(19) United States
(12) Patent Application Publication
(10) Pub. No.: US 2015/0324209 A1
(43) Pub. Date: Nov. 12, 2015

(54) Operating System Switching Method and Dual-Operating System Electronic Device Using the Same

(71) Applicant: Pegatron Corporation, Taipei City (TW)

(72) Inventors: Chia-Hao Hsu, Taipei City (TW); Ching-Sheng Chen, Taipei City (TW)

(21) Appl. No.: 14/705,055

(22) Filed: May 6, 2015

(30) Foreign Application Priority Data
May 8, 2014 (TW) 103116425

(51) Int. Cl. G06F 9/44; G06F 9/445

(52) U.S. Cl. CPC G06F 9/441; G06F 9/445

(57) ABSTRACT

An operating system switching method and a dual operating system electronic device using this method are disclosed. The dual operating system electronic device includes a storage unit, a booting process and a processing unit. The operating system switching method includes the following steps: receiving a launch command corresponding to the representative icon to read the application program data under the status of running the first operating system; creating an operating command in the shared partition for executing the application program and opening the user designated file; writing a switching command in the booting process for booting with the second operating system; rebooting with the second operating system according to the switching command; and executing the application program and opening the user designated file under the status of running the second operating system according to the operating command.

### CROSS-REFERENCE TO RELATED APPLICATIONS

This Non-provisional application claims priority under 35 U.S.C. §119(a) on Patent Application No(s). 103116425 filed in Taiwan, Republic of China on May 8, 2014, the entire contents of which are hereby incorporated by reference.

### BACKGROUND

1. Field of Invention

The invention relates to an operating system switching method for a dual operating system electronic device.

2. Related Art

Along with the rapid development of electronic technologies, a variety of electronic products, such as tablet PCs, notebook computers, desktop computers, smartphones, PDAs (personal digital assistants), electronic books, digital frames, digital music players, electronic dictionaries and GPS navigation devices, greatly enriched the consumer market and fulfilled the work and entertainment needs of the people. Except for the compactness and the aesthetics design, consumers also consider the usage convenience as a reference when selecting an electronic product.

The operation of an electronic device is driven by its operating system. Take the state-of-the-art tablet PC as an example, the Android operating system has various compatible applications for users to download, which is quite entertaining However, applications for business purposes, such as Office for document editing, Visual Studio for programming, OrCad for circuit design, have been developed and used under the Windows operating system for a long time, and are difficult to be replaced. To fulfill both the entertainment and business needs, it is not economic to buy two electronic devices for two operating systems respectively. Therefore, a dual operating system tablet PC has been available on the market for the user to switch between different operating systems.

However, when switching the operating system, it is often necessary to shut down the current operating system and then boot up another one. The executing applications would therefore be forced to shut down, and it is difficult for the user resume the previous works. On the other hand, data cannot be shared between different operating systems, and it is difficult to know which application under another operating system is also compatible to the current operating system.

### SUMMARY

The objective of the invention is to provide an operating system switching method for an electronic device to enhance the convenience of opening files.

Another objective of the invention is to provide an operating system switching method for an electronic device that can save system resource.

Another objective of the invention is to provide a dual operating system electronic device that is more convenient when opening files.

Another objective of the invention is to provide a dual operating system electronic device that occupies less system resource when opening files.

The electronic device using the operating system switching method of the invention includes a storage unit, a booting process and a processing unit. The storage unit has a shared partition and stores a user designated file, and an application program for opening the user designated file. The shared partition includes an application program data corresponding to the user designated file or the application program and a representative icon corresponding to the user designated file or the application program. The processing unit is capable of selectively running a first operating system or a second operating system. The operating system switching method includes the steps of: receiving a launch command corresponding to the representative icon to read the application program data under the status of running the first operating system; creating an operating command in the shared partition for executing the application program and opening the user designated file when the user designated file is only compatible with the second operating system; writing a switching command in the booting process for booting with the second operating system; rebooting with the second operating system according to the switching command; and executing the application program and opening the user designated file under the status of running the second operating system according to the operating command.

In another embodiment, the operating system switching method further includes the following steps: showing an operating system selecting menu when the user designated file is compatible with both the first operating system and the second operating system; receiving an instruction to open the user designated file under the first operating system or the second operating system; opening the user designated file when receiving an instruction to open the user designated file under the first operating system; performing the following steps when receiving an instruction to open the user designated file under the second operating system: creating the operating command in the shared partition for executing the application program and opening the user designated file; writing the switching command in the booting process for booting with the second operating system; rebooting with the second operating system according to the switching command; and executing the application program and opening the user designated file under the status of running the second operating system according to the operating command.

In another embodiment, the operating system switching method further includes the following steps: judging whether an operating system configuration file exists in the shared partition under the status of running the second operating system, wherein the operating system configuration file includes a file list and the representative icon corresponding to the user designated file or the application program and being compatible with the first operating system; obtaining the application program data and the representative icon from the operating system configuration file when the operating system configuration file exists; generating the file list and the representative icon to create the operating system configuration file when the operating system configuration file does not exist; and reading the operating system configuration file to provide to a user interface to create the launch command under the status of running the first operating system.

In another embodiment, the operating system switching method further includes: providing a directory watcher to update the operating system configuration file in view of a change in the shared partition. In another embodiment, the operating system switching method further includes providing a power event watcher to monitor the change of the electronic device running the operating system; and executing the application program and opening the user designated file by the power event watcher according to the operating command when the second operating system is running In another embodiment, the operating system switching method further includes providing a configuration watcher to monitor the change in the operating system configuration file of the electronic device.

The dual operating system electronic device of the invention includes a storage unit, a booting process and a processing unit. The storage unit has a shared partition and stores a user designated file, and an application program for opening the user designated file, the shared partition including an application program data corresponding to the user designated file and a representative icon corresponding to the user designated file or the application program. The booting process is coupled with the storage device. The processing unit is coupled with the storage unit and the booting process. The processing unit is capable of selectively running a first operating system or a second operating system. Under the status of running the first operating system, the processing unit receives a launch command corresponding to the representative icon to read the application program data. When the user designated file is only compatible with the second operating system, the processing unit creates an operating command in the shared partition for executing the application program and opening the user designated file, writes a switching command in the booting process for booting with the second operating system, reboots with the second operating system according to the switching command, and executes the application program and opens the user designated file under the status of running the second operating system according to the operating command

In another embodiment, when the user designated file is compatible with both the first operating system and the second operating system, an operating system selecting menu is shown. The processing unit receives an instruction to open the user designated file under the first operating system or under the second operating system. When receiving the instruction to open the user designated file under the first operating system, the processing unit opens the user designated file. when receiving the instruction to open the user designated file under the second operating system, the processing unit creates the operating command in the shared partition for executing the application program and opening the user designated file, writes the switching command to the booting process for booting with the second operating system, boots with the second operating system according to the switching command, and executes the application program and opens the user designated file under the status of running the second operating system according to the operating command.

In another embodiment, the share partition includes an operating system configuration file; wherein the operating system configuration file includes a file list and the representative icon compatible with the first operating system and corresponding to the user designated file or the application program. The first operating system includes a user interface created in view of the operating system configuration file. The user interface is for creating the launch command.

Through the operating system switching method of the invention, the user can issue a launch command simply by, for example, clicking the representative icon to make the electronic device save the system status and the executing programs automatically to enter into hibernation or suspension and switch to a different operating system.

### BRIEF DESCRIPTION OF THE DRAWINGS

FIG. 1A is a schematic diagram of the dual operating system electronic device according to an embodiment of the invention.

FIG. 1B is a schematic diagram showing that the shared partition includes the operating system configuration file according to an embodiment of the invention.

FIG. 2 is a schematic flowchart of the operating system switching method according to an embodiment of the invention.

FIG. 3 is a schematic flowchart of the operating system switching method according to a different embodiment of the invention.

FIG. 4 a schematic flowchart of obtaining the application program data in the operating system switching method according to an embodiment of the invention.

### DETAILED DESCRIPTION OF THE EMBODIMENT

The operating system switching method of the invention is for the use of an electronic device. The electronic device may be a tablet PC, a notebook computer, a desktop computer, a smartphone, a PDA (personal digital assistant), an electronic book, a digital frame, a digital music player, an electronic dictionary, or a GPS navigation device.

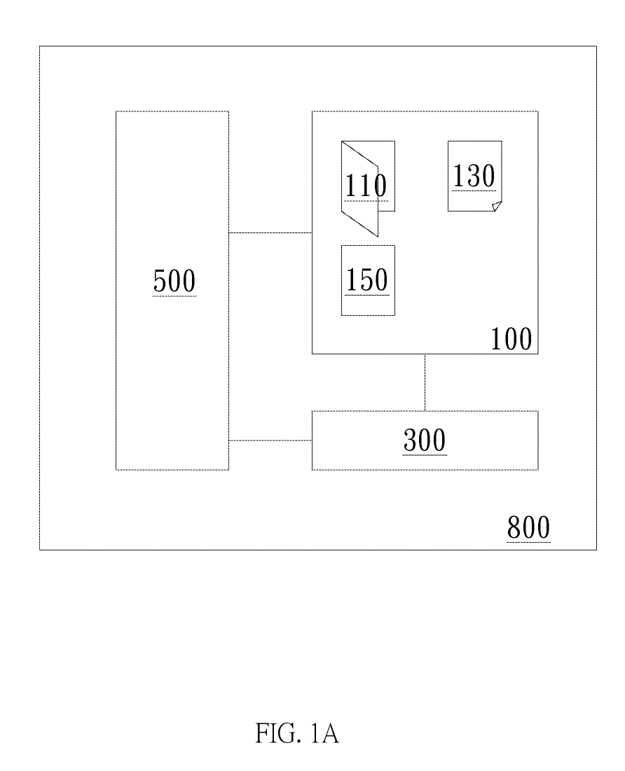

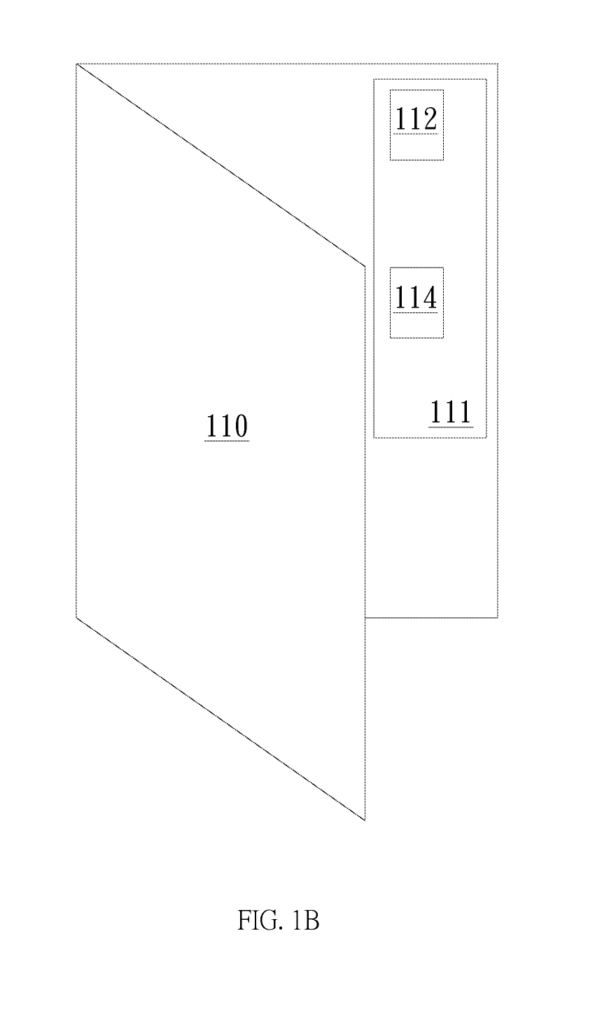

As shown FIG. 1A, the electronic device 800 using the operating system switching method according to an embodiment of the invention includes a storage unit 100, a booting process 300 and a processing unit 500. The booting process includes BIOS (basic input output system), EFI (extensible firmware interface), or any programs for booting an electronic device. The booting process may include booting parameters, such as a switch command or a command for normal power on. The storage unit 100 has a shared partition 110 and stores a user designated file 130, and an application program 150 for opening the user designated file. The shared partition 110 includes application program data corresponding to the user designated file or the application program, and representative icon corresponding to the user designated file or the application program. In one embodiment, the storage unit 100 is a hard disc drive, and the shared partition is a block divided from the tracks. However, in different embodiments, the storage unit 100 may be a device for storing information using electric, magnetic or optical means, including but not limited to a solid state disk, an optical drive or a memory card. The shared partition may be different partitions in the same storage unit (such as a disk partition of a hard disc drive), or one of the designated storage unit among multiple storage units.

The user designated file may be any file pre-determined by the user. The application program data corresponding to the user designated file or the application program generally refer to the data needed when opening the user designated file, such as the application program that should be used to open the file and the location of this application program. The application program data and the representative icon may be created by an installation program during the installation of the application program, or designated by the user after the application program is installed.

As shown in FIG. 1A, the booting process 300 is coupled with the storage unit 100. In one embodiment, the booting process 300 is integrated with the storage unit 100. The processing unit 500 is coupled with the storage unit 100 and the booting process 300. The processing unit 500 can selectively execute the first operating system or the second operating system. The processing unit 500 may by a central processing unit (CPU). The first operating system and the second operating system may be but not limited to the Android operating system and the Windows operating system.

In the embodiment shown in FIG. 1B, the shared partition 110 includes an operating system configuration file 111, wherein the operating system configuration file 111 includes a file list 112 and a representative icon 114 that are compatible with the first operating system and correspond to the user designated file or the application program.

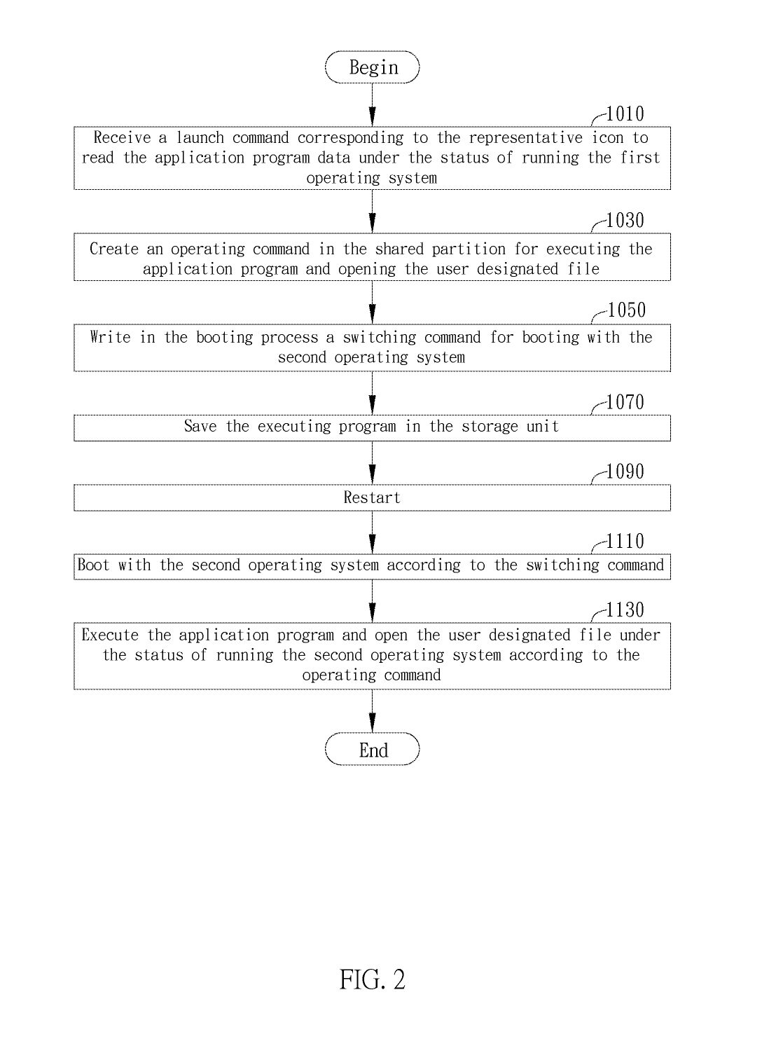

In one embodiment, the user designated file is only compatible with the second operating system or the application program under the second operating system. That is, this user designated file can only be opened under the status that the electronic device 800 is running the second operating system. The reason that results in such limitation may be that the format of the user designated file is different from that of the first operating system, or the application program for opening the user designated file cannot be run under the first operating system. In this embodiment, as shown in FIG. 2, the operating system switching method includes the following steps.

In step 1010, under the condition that the first operating system is running, the launch command corresponding to the representative icon is received to read the application program data. The application program data corresponds to the user designated file or the application program, and the representative icon is an iconized hyperlink of reading the application program data in the shared partition. In a preferred embodiment, the launch command includes the signal of clicking the representative icon. Specifically, when the user clicks the representative icon in the shared partition of the storage unit 100 of the electronic device 800 shown in FIG. 1 to open the user designated file or an application program (without designating any specific file), the processing unit 500 receives the launch command when running the first operating system and reads the application program data in the shared partition.

In step 1030, the operating command is created to execute the application program and to open the user designated file. Specifically, the processing unit 500 shown in FIG. 1 writes the operating command of “executing the application program and opening the user designated file” to the shared partition 110 of the storage unit 100 in view of the launch command as the basis of executing the application program and opening the user designated file after the electronic device 800 is rebooted. In other words, the operating command is in a format readable under the second operating system.

In step 1050, the switching command of booting with the second operating system is written in the booting process. Specifically, the processing unit 500 shown in FIG. 1 writes the switching command of “booting with the second operating system” in the booting process based on the launch command described above as the basis of booting with the second operating system next time the electronic device 800 is rebooted.

In step 1070, the running program is stored in the storage unit. In the present embodiment, the processing unit 500 shown in FIG. 1 stores the running program in the storage unit for resuming it back to the current status next time the first operating system is used for booting. However, this step can be skipped to proceed with the next step directly.

Next, the electronic device 800 is rebooted with the second operating system according to the switching command. In detail, in step 1090, the device is restarted. Specifically, the processing unit 500 shown in FIG. 1 runs the restart procedure of the electronic device 800. Moreover, it is preferred to run the hibernation or suspension procedure before restarting the device.

In step 1110, the processing unit 500 shown in FIG. 1 boots up the device with the second operating system according to the switching command.

In step 1150, the application program is executed and the user designated file is opened according to the operating command under the status of running the second operating system. Specifically, the processing unit 500 shown in FIG. 1 executes the application program and opens the user designated file under the status of running the second operating system according to the operating command of “executing the application program and opening the user designated file” written in the shared partition. In a preferred embodiment, after restarting the electronic device 800 and booting with the second operating system, the processing unit 500 reads the operating command in the shared partition 100 to execute the application program and open the user designated file.

As shown in the embodiment above, using the operating system switching method of the invention, the electronic device can switch between different operating systems conveniently. Furthermore, when the electronic device is running one operating system and needs to open a user designated file or execute an application program that is only compatible with another operating system, it is only necessary to receive, for example, the launch command from the user by clicking the representative icon of this user designated file or the application program. The current system status and the executing programs are stored automatically to enter into a hibernation or suspension mode, and another operating system is used for rebooting to open this user designated file. The embodiment of this method not only is convenient for the user to use the electronic device, but also save the system resources since the electronic device runs only operating system at one time.

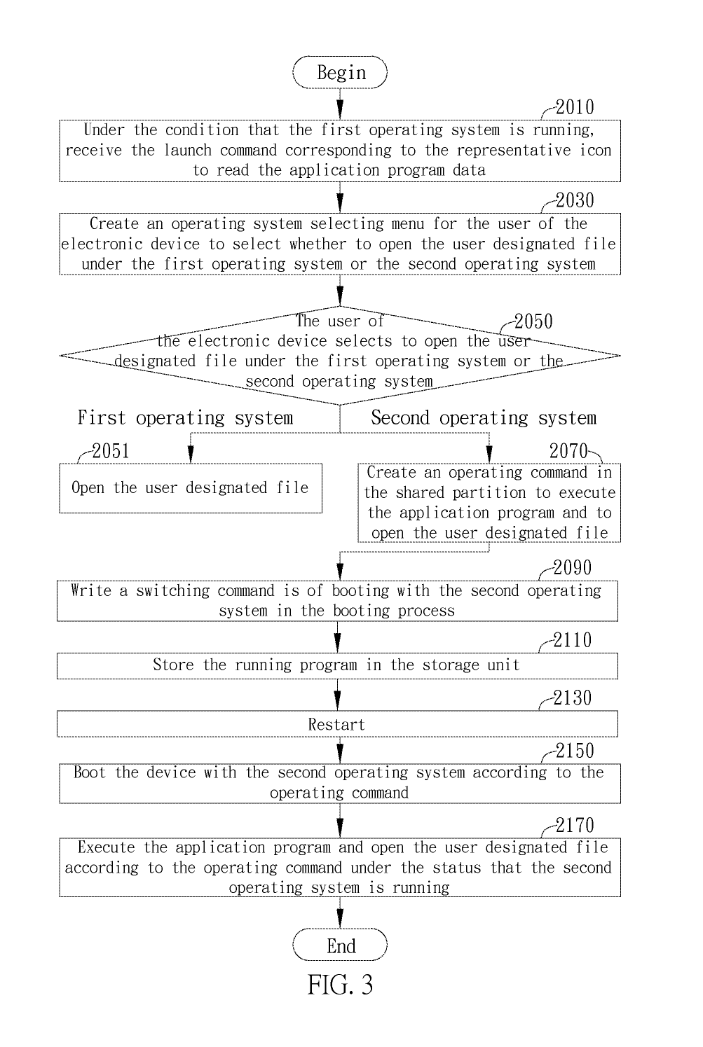

In another embodiment, the user designated file is compatible with both the first operating system and the second operating system. Possible situation includes but not limited to that the user designated file can be opened by different application programs and these application programs are compatible to the first operating system and the second operating system, respectively. Or, although the user designated file can be opened by one application program only, this application program is compatible with both the first operating system and the second operating system. As shown in FIG. 3, in this different embodiment, the operating system switching method of the invention includes the following steps.

In step 2010, under the condition that the first operating system is running, the launch command corresponding to the representative icon is received to read the application program data. In a preferred embodiment, the launch command includes the signal of clicking the representative icon. Specifically, when the user clicks the representative icon in the shared partition of the storage unit 100 of the electronic device 800 shown in FIG. 1 to open the user designated file or an application program, the processing unit 500 receives the launch command and reads the application program data in the shared partition.

In step 2030, an operating system selecting menu is created for the user of the electronic device to select whether to open the user designated file under the first operating system or the second operating system. Specifically, when the application program data indicates that the user designated file is compatible with the first operating system and the second operating system, the processing unit 500 shown in FIG. 1 creates the operating system selecting menu and shows to preferably on the display of the electronic device for the user of the electronic device to select whether to open the user designated file under the first operating system or the second operating system.

In step 2050, when the user of the electronic device selects to open the user designated file under the first operating system, which means that the electronic device receives a command to open the user designated file under the first operating system, step 2051 is performed to open the user designated file. Moreover, if the user of the electronic device selects to open the user designate file under the second operating system, which means that the electronic device receives a command to open the user designated file under the second operating system, the following steps are performed.

In step 2070, an operating command is created in the shared partition to execute the application program and to open the user designated file. Specifically, the processing unit 500 shown in FIG. 1 writes the operating command of “executing the application program and opening the user designated file” to the shared partition of the storage unit 100 as the basis of executing the application program and opening the user designated file after the electronic device 800 is rebooted.

In step 2090, a switching command is of booting with the second operating system is written in the booting process. Specifically, the processing unit 500 shown in FIG. 1 writes the switching command of “booting with the second operating system” in the booting process as the basis of booting with the second operating system next time the electronic device 800 is rebooted.

In step 2110, the running program is stored in the storage unit. Specifically, the processing unit 500 shown in FIG. 1 stores the running program in the storage unit for resuming it back to the current status next time the first operating system is used for booting. However, this step can be skipped to proceed with the next step directly.

In step 2130, the device is restarted. Specifically, the processing unit 500 shown in FIG. 1 runs the restart procedure of the electronic device 800.

In step 2150, the processing unit 500 shown in FIG. 1 boots the device with the second operating system according to the operating command. Specifically, after the reboot of the electronic device 800 shown in FIG. 1, the processing unit 500 boots with the second operating system according to the switching command of “booting with the second operating system” written in the booting process.

In step 2170, the application program is executed and the user designated file is opened according to the operating command under the status that the second operating system is running. Specifically, the processing unit 500 shown in FIG. 1 executes the application program and opens the user designated file under the status that the second operating system is running according to the operating command of “executing the application program and opening the user designated file” written in the shared partition. In a preferred embodiment, after restarting the electronic device 800 and booting with the second operating system, the processing unit 500 reads the operating command in the shared partition 100 to execute the application program and open the user designated file.

Furthermore, the feature of this embodiment is that when the user designated file is compatible with both the first operating system and the second operating system, the electronic device can create an operating system electing menu for the user of the electronic device to select whether to open the user designated file with the first operating system or the second operating system. The user may select to open the user designated file with the currently-running first operating system to save the time of rebooting, or select to open the user designated file with another operating system (that is, the second operating system) after rebooting with certain functional considerations (such as whether the file can be opened completely and whether the file can be edited after being opened).

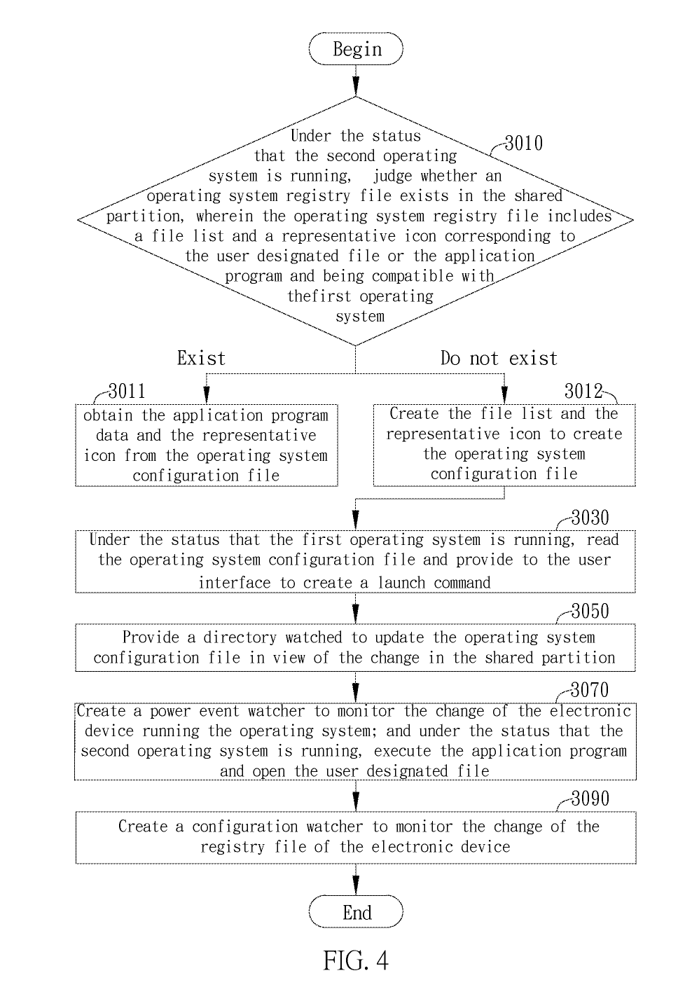

As shown in FIG. 4, the operating system switching method according to the previous embodiment further includes the following steps.

In step 3010, under the status that the second operating system is running, it is judged whether an operating system configuration file exists in the shared partition. The operating system configuration file includes a file list and a representative icon corresponding to the user designated file or the application program and being compatible with the first operating system. “Being compatible with the first operating system” includes but not limited to being able to be viewed when the electronic device is running the first operating system.

When the operating system configuration file exists, step 3011 is performed to obtain the application program data and the representative icon from the operating system configuration file.

When the operating system configuration file does not exist, step 3012 is performed to create the file list and the representative icon to create the operating system configuration file. Specifically, a file list and a representative icon compatible with the first operating system are created to create the operating system configuration file.

In step 3030, under the status that the first operating system is running, the operating system configuration file is read and provided to the user interface to create a launch command.

Furthermore, by performing steps 3010 to 3030, the “application program data” and the “representative icon” required in step 1010 or step 2010 are created. In other words, the steps 3010 to 3030 described above can be viewed as the “preparation” prior to the step 1010 or step 2010, and it is preferred to perform steps 3010 to 3030 prior to the step 1010 and step 2010 shown in FIG. 2 and FIG. 3, respectively.

As shown in FIG. 4, in a preferred embodiment, the following steps are included after step 3310 or step 3030 is performed.

In step 3050, a directory watched is provided to update the operating system configuration file in view of the change in the shared partition. The change in the shared partition includes the change of the user designated file or the application program. Specifically, when the user designated file or the application program is changed due to a creation, a deletion or a version update, the directory watcher can automatically update the operating system configuration file so that the file list and the representative icon included in the operating system configuration file can correspond to the user designated file or the application program.

In step 3070, a power event watcher is created to monitor the change of the electronic device running the operating system. The power event watcher executes the application program and opens the user designated file according to the operating command when the second operating system is running.

In step 3090, a configuration watcher is created to monitor the change of the operating system configuration file of the electronic device. The change of the operating system configuration file of the electronic device includes the change of the identification of the designated disk drive.

To sum up, through the operating system switching method of above disclosure, the user can issue a launch command simply by, for example, clicking the representative icon to make the electronic device save the system status and the executing programs automatically to enter into hibernation or suspension and switch to a different operating system. Moreover, when the user designated file is compatible with both the first operating system and the second operating system, the user can choose to open the user designated file with the current first operating system or to open the user designated file after rebooting with another operating system. Furthermore, the operating system switching method of the embodiment of the invention can prepare the “application program data” and the “representative icon” through a preparation process to facilitate the switch of the operating system.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An operating system switch method for an electronic device, the electronic device including a storage unit, a booting process and a processing unit, the storage unit having a shared partition and storing a user designated file, and an application program for opening the user designated file, the shared partition including an application program data corresponding to the user designated file or the application program and a representative icon corresponding to the user designated file or the application program, the processing unit being capable of selectively running a first operating system or a second operating system, the operating system switching method comprising the steps of:
receiving a launch command corresponding to the representative icon to read the application program data under the status of running the first operating system;
creating an operating command in the shared partition for executing the application program and opening the user designated file when the user designated file is only compatible with the second operating system;
writing a switching command in the booting process for booting with the second operating system;
rebooting with the second operating system according to the switching command; and
executing the application program and opening the user designated file under the status of running the second operating system according to the operating command.

2. The operating system switching method according to claim 1, further comprising the steps of:
showing an operating system selecting menu when the user designated file is compatible with both the first operating system and the second operating system;
opening the user designated file when receiving an instruction to open the user designated file under the first operating system, and performing the following steps when receiving an instruction to open the user designated file under the second operating system:
creating the operating command in the shared partition for executing the application program and opening the user designated file;
writing the switching command in the booting process booting with the second operating system;
rebooting with the second operating system according to the switching command; and
executing the application program and opening the user designated file under the status of running the second operating system according to the operating command.

3. The operating system switching method according to claim 1, further comprising the steps of:
judging whether an operating system configuration file exists in the shared partition under the status of running the second operating system, wherein the operating system configuration file includes a file list and the representative icon corresponding to the user designated file or the application program and being compatible with the first operating system;
obtaining the application program data and the representative icon from the operating system configuration file when the operating system configuration file exists;
generating the file list and the representative icon to create the operating system configuration file when the operating system configuration file does not exist; and
reading the operating system configuration file to provide to a user interface to create the launch command under the status of running the first operating system.

4. The operating system switching method according to claim 3, further comprising:
providing a directory watcher to update the operating system configuration file in view of a change in the shared partition.

5. The operating system switching method according to claim 1, further comprising:
providing a power event watcher to monitor a change of the electronic device running the operating system; and
executing the application program and opening the user designated file by the power event watcher according to the operating command when the second operating system is running.

6. The operating system switching method according to claim 1, further comprising:
providing a configuration watcher to monitor a change in the operating system configuration file of the electronic device.

7. The operating system switching method according to claim 1, wherein the launch command includes a signal of clicking the representative icon.

8. A dual operating system electronic device, comprising:
a storage unit having a shared partition and storing a user designated file, and an application program for opening the user designated file, the shared partition including an application program data corresponding to the user designated file and a representative icon corresponding to the user designated file or the application program;
a booting process coupled with the storage device; and
a processing unit coupled with the storage unit and the booting process,
wherein
the processing unit is capable of selectively running a first operating system or a second operating system,
under the status of running the first operating system, the processing unit receives a launch command corresponding to the representative icon to read the application program data,
when the user designated file is only compatible with the second operating system, the processing unit
creates an operating command in the shared partition for executing the application program and opening the user designated file,
writes a switching command in the booting process for booting with the second operating system,
reboots with the second operating system according to the switching command, and
executes the application program and opens the user designated file under the status of running the second operating system according to the operating command.

9. The dual operating system electronic device according to claim 8, wherein
when the user designated file is compatible with both the first operating system and the second operating system, an operating system selecting menu is shown,
the processing unit receives an instruction to open the user designated file under the first operating system or under the second operating system,
when receiving the instruction to open the user designated file under the first operating system, the processing unit opens the user designated file,
when receiving the instruction to open the user designated file under the second operating system, the processing unit
creates the operating command in the shared partition for executing the application program and opening the user designated file,
writes the switching command in the booting process for booting with the second operating system,
reboots with the second operating system according to the switching command, and
executes the application program and opens the user designated file under the status of running the second operating system according to the operating command.

10. The dual operating system electronic device according to claim 8, wherein
the shared partition includes an operating system configuration file;
the operating system configuration file includes a file list and the representative icon compatible with the first operating system and corresponding to the user designated file or the application program.

11. The dual operating system electronic device according to claim 10, wherein the first operating system includes a user interface created in view of the operating system configuration file, the user interface is for creating the launch command.
